(19) United States
(12) Patent Application Publication
(10) Pub. No.: US 2004/0054564 A1
(43) Pub. Date: Mar. 18, 2004

(54) Systems and methods for the optimization of resources in energy markets

(76) Inventors: Adolfo M. Fonseca, Raleigh, NC (US); John D. Finney, Raleigh, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/246,162

(22) Filed: Sep. 17, 2002

(51) Int. Cl. G06F 17/60

(52) U.S. Cl. 705/7

(57) ABSTRACT

The optimization of resources for energy markets is provided. In an illustrative implementation, the systems and methods described herein comprise an exemplary computing application operating in a computing environment that cooperates with a repository having at least one computational equation, rule, and/or model and executing a computational model engine that employs computational equations, rules, and/or models that generates behavior information for an observed system. In operation, energy market characteristic information acts as input to the exemplary computing application which executes the computational model engine that processes the energy market characteristic information using the computational equations, rules and/or models to produce power system behavior data. This behavior data is then acted upon by the exemplary computing application to generate optimization solutions to optimize power distribution resources.

### FIELD OF THE INVENTION

The present invention relates generally to the optimization of the production and trading of resources, and more particularly to modeling the behavior of energy markets to provide optimization information be used in making power system operating decisions and in the effort to increase profitability from the transaction of generated power.

### BACKGROUND OF THE INVENTION

Process optimization is tantamount to success in the business world. This activity takes on many forms and encompasses various elements. From resource allocation to requests for quotes, process optimization assists business operators to better define process parameters (e.g. business process, manufacturing process, etc.) in an effort to meet customer demands and to better react to changes in market conditions. A crucial component of process optimization is the determination of environment variables that when taken alone and/or in the aggregate directly effect process execution performance. Often, early process optimization analysis will determine if a contemplated process will efficiently and reliably perform at execution. Process optimization analysis is generally a dynamic undertaking wherein a rough approximation is first calculated and then is fined tuned as more process specifications and details become known. Various industries participate in these activities hoping to optimize resources among concurrent and competing processes. The power systems and equipment industry is not immune from these activities.

Energy market makers are often charged with the task of quickly responding to varying market conditions (e.g. consumer power needs) that vary depending on forecasted and, sometimes, not so forecasted events. Typically, energy market makers will be responsible for determining the allocation of power resources to accommodate the various needs placed on the power system. In the context of power generation plants, not only is the output power managed but also all of the required resource inputs (e.g. hydro resources, thermal resources, etc.). For example, in a hydro-electric power distribution plant, the use and management of hydro resources will directly impact the amount of power that is generated. Tight control over such hydro resources can lead to a non-robust and less than adaptable power system and consequently a less responsive energy market. The converse, loosely organized and managed hydro resources can result in drastic power generation losses rendering the power system inefficient and non-optimal.

Currently, energy market participants employ traditional computational techniques when determining and managing available resources (and to determine the impact of resources on the overlying power system). These computational techniques range from simple addition and subtraction of resource inventory to more complicated linear and non-linear computational models that help forecast resource consumption rates and resource allocation to achieve desired power yields. With the advances in computing some of these computational models have become complex and awkward. However, even with their complexities, current optimization computational models do not comprehensively account for the non-linear dynamical behavior of power system resources. That is, as the power system adapts to unpredictable market conditions, weather, and resource fluctuations, current optimization models fall short to provide optimization values that implemented would most accurately optimize the changing power system and better model energy market conditions. Moreover, even with the latest computational models, significant manual labor is required to correlate resource determination, management, and deployment with other power system variables in the overall effort to manage and deploy power to needy consumers.

From the foregoing it can be appreciated that there exists a need for comprehensive systems and methods that allow energy market participants to more easily perform resource optimization analysis of using computational models that better model the non-linear characteristics of power systems. By having systems and methods the shortcomings of the prior art are overcome.

### SUMMARY OF THE INVENTION

Systems and methods for optimizing resources and the associated trading of generated power of energy markets using various computational models are provided. In an illustrative implementation, the systems of the present invention comprise an exemplary computing application operating in a computing environment that cooperates with repository having a levy of computational equations and rules, and cooperates with computational model engine having at least one processing rule to process at least one computational equation, model, and/or rule. In operation, energy market characteristic information describing the non-linear behavior of the observed energy market (e.g. including observed power systems) and energy market logical constraint information acts as input to the exemplary computing application. Using this information, at least one energy market model is generated to describe the behavior of the observed energy market. The energy market characteristic information takes into account a plethora of power system variables and values. The energy market characteristic information (e.g. non-linear equations describing the behavior of the observed energy market) and logical constraint information is processed by the computational model engine to solve at least one linearized equation and/or model that describes the energy market behavior. In the exemplary implementation, the linearized equation (s) is/are solved using conventional linear programming techniques. Furthermore, using the energy market behavior information, the exemplary computing application processes the energy market behavior to generate resource optimization solutions that aim to maximize resource consumption and to maximize profits that may be realized from the sale of the generated energy-energy (e.g. power) generated using the described resources.

Other features of the disclosed systems and methods are described below.

### BRIEF DESCRIPTION OF THE DRAWINGS

The system and methods for the optimization of resources and maximization of energy market profits of energy markets are further described with reference to the accompanying drawings in which:

FIG. 1 is a system diagram of an exemplary computing environment;

FIG. 1A is a system diagram of an exemplary computing network environment;

FIG. 1B is a system diagram showing the interaction between exemplary computing components;

FIG. 2 is a block diagram of the architecture of an exemplary computing application providing resource optimization features;

FIG. 3 is a flow diagram of the processing performed to obtain the necessary input for the resource optimization computational model; and

FIG. 4 is a flow diagram of the processing performed by the exemplary computing application when providing optimization values using a preferred resource computational model.

### DETAILED DESCRIPTION OF ILLUSTRATIVE IMPLEMENTATION

Overview:

Resource management and optimization is critical to the efficient operation and generation of profits for systems. In the context of complicated energy markets, resource optimization and management becomes tantamount to success in the marketplace. Energy markets are not immune from these simple requirements. In fact, energy markets and the power systems that comprise energy markets, by their nature, require significant amounts of natural and manufactured resources to sustain proper operation. Moreover, power systems of energy markets are required to be adaptable and configurable so as to meet the ever changing needs of its power customers. All of these factors taken in the aggregate create significant challenges to power energy market participants that are not easily surmounted without the assistance of optimization tools, such as computational models.

In the context of hydro-electric power systems, a key resource management issue is hydro-thermal resource management. Hydrothermal scheduling is an important daily activity for utilities because of its significant economic impact. It aims at determining the commitment and generation of all schedulable power resources over a planning horizon to meet the system demands and reserve requirements. The goal is to maximize profits realized from the generation and sale of power. To solve this NP-hard mixed integer programming problem, many algorithms have been developed and are employed. Langrangian relaxation and dynamic programming and its extension are among the most successful. Even in the context of these solution techniques, there exists many features when modeling the power systems that they do not account for in detail and as a result they present significant challenges when trying to optimize the hydro resources of the power system.

It is appreciated that although a hydroelectric power system has been described as the observed system on which to perform resource optimization (i.e. hydro resource optimization) that the inventive concepts described herein are not limited to this particular scenario but rather may be applied to optimize various resources of power systems having various configuration. Specifically, the inventive concepts described herein may be applied to provide optimization information for various power system resources found in various energy markets including but not limited to: thermal resources, fuel resources, heat resources, system security resources, and fuel network resources. Also, the inventive concepts described herein provide optimization information for use in determining market information. In this capacity, the inventive concepts described herein may generate and provide market optimization information.

The present invention, aims to ameliorate the shortcomings of existing deficient modeling practices rendering a more palatable and acceptable means for generating optimization information for an observed energy market (e.g. power system). Specifically, the inventive concepts described herein contemplate generating models that describe energy market using detailed rules (e.g. market rules, client rules, general operating rules), constraint information, and operation conditions. In doing so, the resulting model is more comprehensive and inclusive such that it better describes the behavior of the energy market, and more importantly serves as a better basis to generate desired optimization information-optimization information if employed would exploit the optimal output for an energy market.

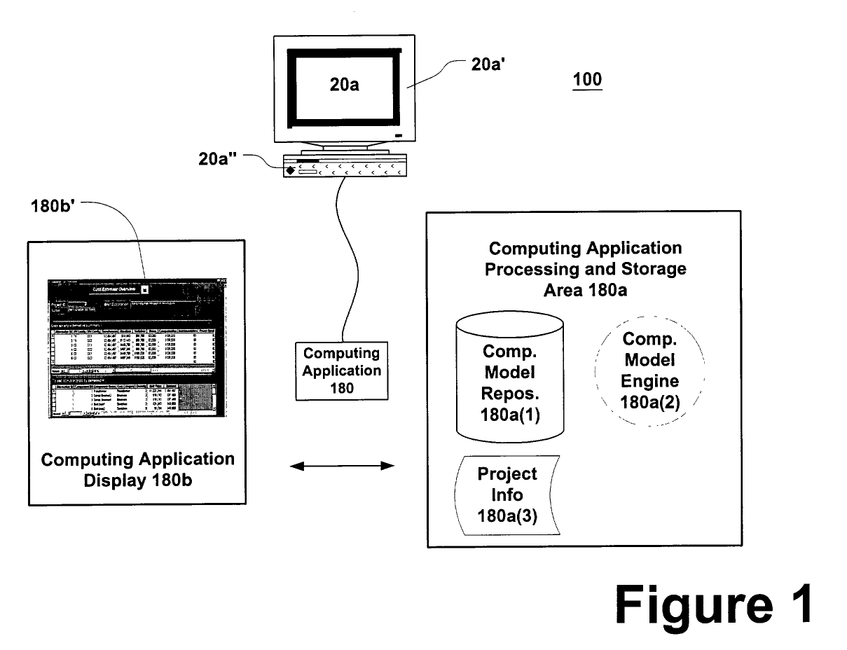

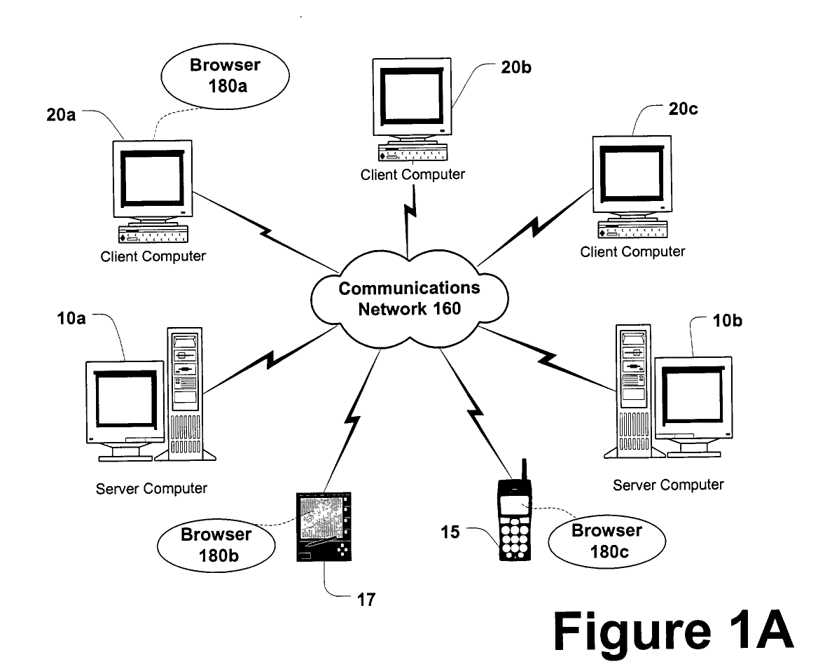

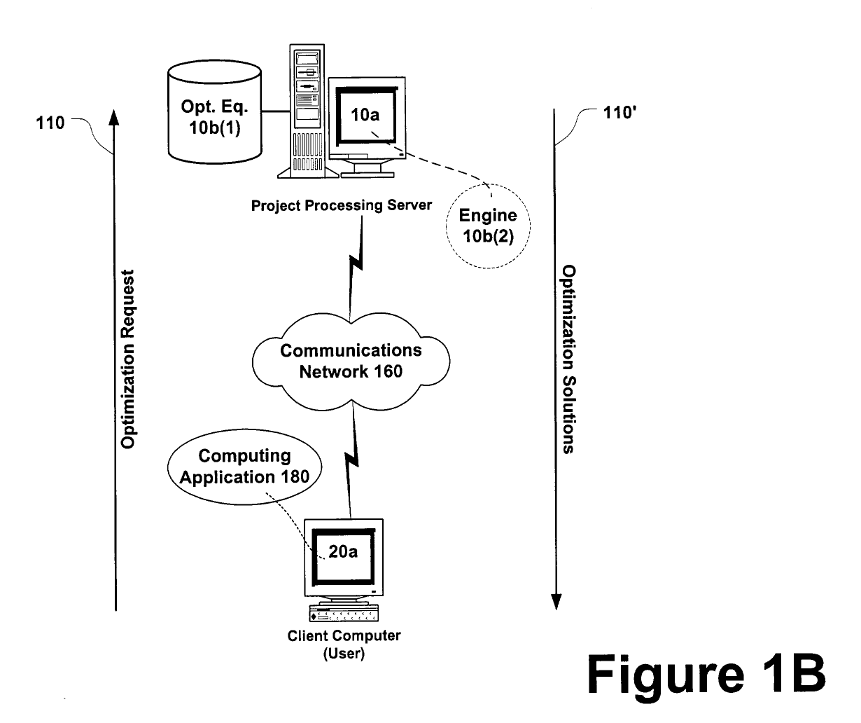

As will be described below with respect to FIGS. 1-4, the systems and methods described herein provide a best of breed computational model solution approach to resource optimization and as such aim to ameliorate the shortcomings of existing techniques and conventions. In a contemplated illustrative implementation, the systems and methods described herein provide a linear optimization of resources for a power system of an energy market that may be mathematically modeled using non-linear power system characteristic information and logical constraints to generate at least one linearized equation representative of the power system (and energy market) behavior. This modeling information may be then solved using a best of breed solution approach to provide energy market optimization data. Using this data, energy market participants are better poised to configure energy market controllable variables to achieve the desired optimization. Furthermore, the systems and methods described herein may provide relevant information to the trading of power in either a regulated or deregulated electricity market. In using one or more computational models, the system and methods described herein achieve to overcome the above-described constraints in an efficient and reliable manner. As such, the system and methods disclosed herein provide a better representation of energy market behavior and optimization that is not currently realized by existing practices and techniques.

In an exemplary implementation, the inventive concepts may be applied to provide hydro resource optimization. Included in the hydro resource optimization computational model work products are: maximization of water use for electricity generation; ensuring smooth water flow variations through time; ensuring coordination of water release among existing reservoirs; eliminating unnecessary water storage at the beginning of each week; ensuring coordination between production and pumping; reduction of potential water spillage; and coordination of trading and operation with one application.

In an illustrative implementation, the systems and methods described herein comprise an exemplary computing application operating in a computing environment that cooperates with a computational model engine and associated computational equation, rules, and model repository to generate optimization data for use by power system operators to more efficiently operate their power systems (and energy markets) in an effort to maximize profitability. The exemplary computing application, in operation, allows for energy market participants to implement one or more (in whole or in part) of the following characteristics when applied to optimizing hydro resources: Arbitrary complexity of cascade hydro configuration with nodes connected by means of arcs; Multiple types of arcs to model different use of the water such as generating, pumping, generating and pumping, bypass, irrigation, aqueduct; Multiple types of nodes to model different storage capabilities such as reservoir, junction, tailwater and ground (It is understood that this is also known as storage and run of the river production and pumping); Spillage risk cost functions to prevent unnecessary spillages from reservoirs; Water value function to account for any future sale of the energy stored in reservoirs at the end of the study horizon; Flow variation constraints to prevent erosion of channel walls or undesirable changes of channels and river levels; Modeling of source and sink nodes of hydro arcs for flow rate and time delay calculations; Modeling of upstream and downstream nodes of hydro arcs for head dependence calculations; Multi-mode units to model different states of unit features such as max/min loading, head dependent or linear production and pumping, variable maintenance cost, variable production costs, startup costs, multiple reserve capabilities, complimentary generating modes for pumping; Multiple types of units such as generating, pumping and generating-pumping; Multiple operating constraints such as scheduled unit commitment, scheduled dispatch, must run operation, planned outages, cycling operation; Initial conditions for unit status and dispatch and for hydro arc flow rates; Historical arc flow rates for time delay consideration; Multiple unit grouping such as power stations, energy transaction groups, reserve transactions groups, network charges transmission zones, join start pumping groups, system configuration, and hydro arc assignment; Load and multiple reserve obligations as well as un-served load and reserves, and surplus generation and reserves; Multiple commodities and products, and multiple transactions on these products; Commodities comprise electrical energy and reserves, while products comprises hourly power, spinning and non-spinning reserves, up and down reserves; Firm and dispatchable transactions of energy and reserves with minimum and maximum obligations; Modeling of location networks charges over net production and net consumption for generating and pumping units; Modeling of cost adders for reservoir under storage and spillages, hydro arc under and over flows, un-served energy and reserve, surplus energy and reserve, unused energy and reserve purchases, un-served energy and reserve sales. These cost adders represent any economic impact of the violation of the respective constraints on the system under consideration; Configurable time period resolution from one minute to any number of hours.

It is understood that the work product list and characteristic list are not inclusive as the inventive concepts described herein could be used to generate data about additional non-disclosed energy market (and power system) characteristics and work products. Specifically, the inventive concepts described herein may be applied to provide optimization work products for various energy market resources including but not limited to: thermal resources, fuel resources, heat resources, system security resources, and fuel network resources. Also, the inventive concepts described herein provide optimization work products for use in determining market information. In this capacity, the inventive concepts described herein may generate and provide market optimization information work products.

Illustrative Computing Environment

FIG. 1 shows computing system 100 that may support the present invention. Computing system 100 comprises computer 20a that may comprise display device 20a′ and interface and processing unit 20a″. Computer 20a may support computing application 180. As shown, computing application 180 may comprise computing application processing and storage area 180 and computing application display 180b. Computing application processing and storage area 180a may contain computational equation, rules, and models repository 180a(1), computational model engine 180a(2), and power system data store 180a(3). Similarly, computing application display 180b may comprise display content 180b′. In operation, a participating user (not shown) may interface with computing application 180 through the use of computer 20a. The participating user (not shown) may navigate through computing application 180 to input, display, and generate data representative of power system resource optimization. Resource optimization solutions and analysis may be created by computing application 180 using the computational equation, rules, and models repository 180a(1), computational model engine 180a(2), and power system information 180a(3) of computing application processing and storage area 180a and shown to a participating user (not shown) as display content 180b′ on computing application display 180b.

Illustrative Computer Network Environment

Computer 20a, described above, can be deployed as part of a computer network. In general, the above description for computers applies to both server computers and client computers deployed in a network environment. FIG. 1A illustrates an exemplary network environment, with a server in communication with client computers via a network, in which the present invention may be employed. As shown in FIG. 1A, a number of servers 10a, 10b, etc., are interconnected via a fixed-wire or wireless communications network 160 (which may be a LAN, WAN, intranet, the Internet, or other computer network) with a number of client computers 20a, 20b, 20c, or computing devices, such as, mobile phone 15, and personal digital assistant 17. In a network environment in which the communications network 160 is the Internet, for example, the servers 10 can be Web servers with which the clients 20 communicate via any of a number of known communication protocols, such as, hypertext transfer protocol (HTTP) or wireless application protocol (WAP). Each client computer 20 can be equipped with browser 180a to gain access to the servers 10. Similarly, personal digital assistant 17 can be equipped with browser 180b and mobile phone 15 can be equipped with browser 180c to display and receive various data.

In operation, a participating user (not shown) may interact with a computing application running on a client computing devices to generate resource optimization solutions for energy markets. The optimization solutions may be stored on server computers and communicated to cooperating users through client computing devices over communications network 160. A participating user may create, track, manage, and store project solutions and cost analysis information by interfacing with computing applications on client computing devices. These transactions may be communicated by client computing devices to server computers for processing and storage. Server computers may host computing applications for the processing of optimization information relevant to energy markets.

Thus, the present invention can be utilized in a computer network environment having client computing devices for accessing and interacting with the network and a server computer for interacting with client computers. However, the systems and methods providing resource optimization as described by the systems and methods disclosed herein can be implemented with a variety of network-based architectures, and thus should not be limited to the example shown. The systems and methods disclosed herein will be described in more detail with reference to a presently illustrative implementation.

Power System Solution Generation

FIG. 1B shows the cooperation of various computing elements when generating resource optimization for power systems in a computing environment. A participating user may employ computing application 180a operating on client computer 20a to send a request for resource optimization to project processing server 10a over communications network 160. In response, project processing server 10a may process the request by cooperating with adaptable and updateable computational equation, rules, and models data store 10b(1), and adaptable and updateable computational model engine 10b(2) to generate and communicate resource optimization solutions for the power system resource optimization request. The resource optimization solution information can then be communicated to client computer 20a over communications network 160. At client computer 20a, the resource optimization solution information may be viewed and manipulated by participating users.

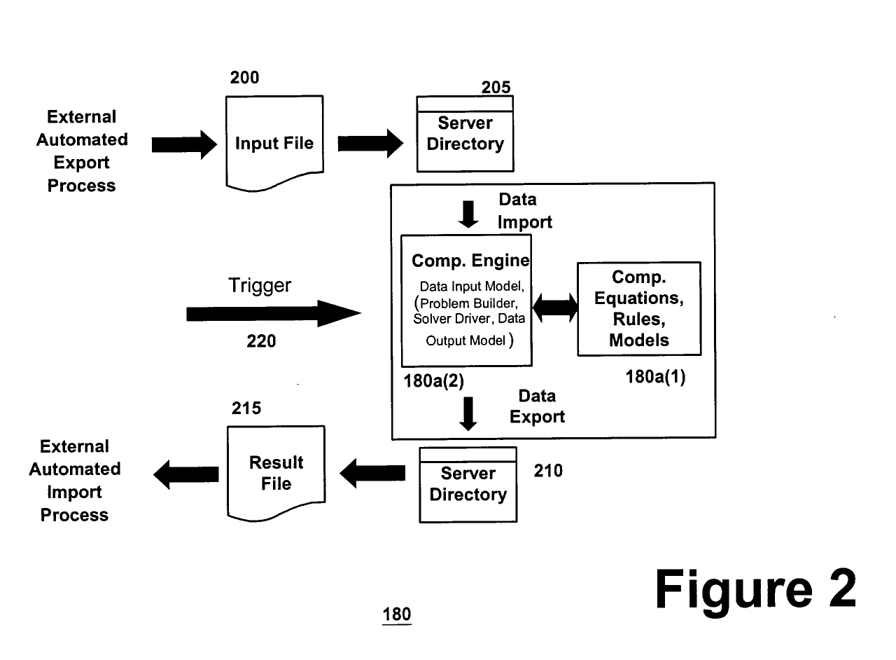

FIG. 2 shows a block diagram of an exemplary architecture that is employed by exemplary computing application 180. As shown, exemplary computing application 180 accepts an input file 200 through server directory 205. The data is imported from server directory 205 by the computational engine 180a(2) and cooperates with computational equations, rules, and models repository 180a(1) to produce optimization data for export through server directory 210. The exported data is then presented in a resultant file 215. In the exemplary implementation provided, the processing begins responsive to an external trigger 220.

In operation, energy market characteristic data, logical constraints (e.g. environmental data, market conditions, resource information, etc.), and rules (e.g. general energy market rules, operating rules—customer driven, and market specific rules) are acquired (e.g. provided by another cooperating computing environment via an automated vial transfer) and inputted to exemplary computing application 180. The input data is communicated by the computing application 180 to the computational model engine 180a(2) for processing. The computational model engine 180a(2) cooperates with the computational model equations, rules, and models repository 180a(1) to obtain the necessary and appropriate computational equations, rules, and models to best serve the inputted data. As described above, when modeling hydro resource allocation for a power system several constraints must be accounted. The number, frequency, and range of constraints will determine which computational models computational model engine 180a(2) will employ to generate resource optimization data. The generated resource optimization data is then provided for use by participating users in a variety of manners including but not limited to a simple display, or through automated transfer of a result file 215 as shown in FIG. 2.

It is appreciated that although a particular computing architecture has been described to perform the inventive concepts described herein that such computing architecture is merely exemplary as the systems and methods disclosed herein may be implemented in various computing architectures operating a variety of computing applications.

In a particular implementation wherein hydro resources are being optimized, the hydro optimization problem may be formulated as a deterministic mixed integer non-linear problem. However, a number of linear equivalent transformations and linear approximations are carried out to convert the problem into a deterministic mixed integer-linear problem so it could be solved using mixed integer-linear programming techniques. One example of the former is the linear transformation of startup conditional constraints, while for the latter is the piecewise approximation of head dependent production function of generating and pumping units. The model includes binary variables, which, despite the linearization, makes the problem a mixed integer-continuous model.

For the exemplary hydro resource optimization implementation, following is the objective function as well as the set of engineering, environmental, operating, market and related constraints included in the exemplary linearized problem.

Exemplary Objective Function:

Maximize {energy sale revenue

+Reserve sale revenue

+Future revenue (water storage in reservoir)

−Penalty cost of un-served energy sale

−Penalty cost of unused energy purchase

−Energy purchase cost

−Reserve purchase cost

−Penalty cost of reservoir minimum violation

−Penalty cost of reservoir spillage

−Reservoir risk spillage cost

−Penalty cost of arc flow rate limit violation

−Penalty cost of arc flow ramp rate limit violation

−Un-served energy cost

−Surplus energy cost

−Un-served reserve cost

−Surplus reserve cost

−Unit maintenance cost

−Unit production start up cost

−Unit pumping start up cost

−Unit variable cost

−Unit group network charges}

Exemplary Constraints:

−Loading and Reserve Coordination by Operating Modes and Power Generation Resources

−Operating Mode Selection

−Start-up of Power Generating Resources in a Given Operating Mode

−Minimize Reserve for Operating Modes of Power Generating Resources

−Constraint Formulation for the Join Start-up in Resource Groups System Reserve Requirement

−System Load Balance Equation

−Hydro Storage Balance Equations

−Constant Production Factor Function for Hydro Power Generating

−Piecewise Linear Production Function for Hydro Power Generating Resources

−Nethead for Hydro Power Generating Resources

−Convex Piecewise Linear Function for the Storage—Surface Water Elevation Relationship of Hydro Storage

−Convex Piecewise Linear Function for Tail-water Surface Evaluation Constraint Formulation for the Flow Ramp Rate of Hydro Arcs

−Constraint Formulation for the Reservoir Seepage Losses

−Constraint Formulation for the Evaporation Losses of Reservoirs

−Constraint Formulation for the Resource Group with Electrical Energy Transaction Assignment

−Constraint Formulation for the Resource Group with Reserve Transaction Assignment

Exemplary Decision Variables (Having Exemplary Lower and Upper Bounds)

−Variable for the Profit of Integrated Problem

−Variable for Energy Sale Revenue by Bucket Limit

−Variable for Cost Adder of Un-served Energy Sales by Bucket Limit

−Variable for the Revenue of Hydro Storage Remaining Energy

−Variable for the Energy Purchases Costs by Bucket Limit

−Variable for the Cost Adder of Un-served Energy Purchases by Bucket Limit

−Variable for Start-Up Costs of Power Generating Resources

−Variable for Shut-Down Costs of Power Generating Resources

−Cost Adder Variables For Un-served/Surplus Energy by System

−Cost Adder Variables for Un-served/Surplus Reserve by System

−Variables for the Cost of Reserve Purchase by System

−Variables for the Revenue of Reserve Sale by System

−Variables for Cost Adder for the Under Storage and Spillage of Reservoir

−Variables for the Cost Adder for the Under and Over Flow Rate of Hydro Arcs

−Variables for the Variable Cost of Maintenance and Production of Power Generating Resources

−Variables for the Costs of the Network Changes of Transmission Zones

−Variables for the Cost Adder of the Over and Under Violation of Flow Ramp Rate of Hydro Arcs

−Variables for the Cost Adder of the Spillage Risk of Reservoirs

−Variable for Start-up Costs of Power Generating Resources

−Variable for Shutdown Costs of Power Generating Resources

−Cost Adder Variables for Un-served/Surplus Energy by System

−Cost Adder Variables for Un-served/Surplus Reserve by System

−Variables for the Cost of Reserve Purchase by System

−Variables for the Revenue of Reserve Sale by System

−Variables for the Cost Adder for the Under Storage and Spillage of Reservoir

−Variables for the Cost Adder for the Under and Over Flow Rate of Hydro Arcs

−Variables for the Variable Cost of Maintenance and Production of Power Generating Resources

−Variables for the Costs of the Network Charges of Transmission Zones

−Variables for the Cost Adder of the Over and Under Violation of Flow Ramp Rate of Hydro Arcs

−Variables for the Cost Adder of the Spillage Risk of Reservoirs

−Future Revenues of the End Storage Monetary Value of Reservoirs

−Status Variables for Operating Mode of Power Generating Resources

−Off Status Variables for Power Generating Resources

−Start-up Variables for Operating Mode of Power Generating Resources

−Loading Variables for Operating Modes of Power Generating Resources

−Variables for the Net Loading and Net Pumping Transmission Zones

−Variables for the Loading of Energy Purchases by Bucket Limit

−Variables for the Un-served Loading of Energy Purchases by Bucket Limit

−Variables for the Loading Energy Sales by Bucket Limit

−Variables for Reserve Purchases

−Variables for Reserve Sales

−Variables for Un-served/Surplus Reserve by System

−Reserve Variables for Operating Modes of Power Generating Resources

−Un-served/Surplus Energy Variables for Systems

−Variables for the Storage of Hydro Storages

−Variables for the Under Storage of Hydro Storages (Reservoirs)

−Variable for the Reservoir Seepage Losses

−Variable fir the Reservoir Evaporation Losses

−Variables for the Flow Rate for Hydro Arcs

−Variables for the Under and Over Flow Rate of Hydro Arcs

−Variable for the Net Head of Hydro Arcs

−Variables for the Weighting in the Piecewise Linear Production Function

−Variable of the Water Surface Elevation of Hydro Storages

−Variable of the Water Surface Incremental Elevation of Reservoirs

−Variable of the Incremental Inflow of Tail-waters

−Variable of the Flow Ramp Rate of Hydro Arcs

−Variable of the Incremental Storage In the Convex Piecewise Cost Adder of Spillage Risk of Reservoirs

−Variable of the Incremental Storage in the Convex Piecewise Revenue of End Storage of Revenues

−Variables for the Allocation of Loading of Power Generating Resources Among Resources Groups

−Variables for the Allocation of Reserve of Power Generating Resources Among Resource Group

As described, computation engine 180a(2) cooperates with computational equations, rules, and models to process energy market characteristic data as well as logical constraints in the effort to generate resource optimization data. In the context of hydro-resource optimization, exemplary logical constraints include but are not limited to: Loading and Reserve Coordination by Operating Modes and Power Generation Resources: Units can produce power and serve to reserve if only if they are on-line; Operating Mode Selection: A unit can operating is just one mode at any time; Startup of Power Generating Resources in a Given Operating Mode: A startup occurs when the unit switch its state from off-line to on-line in a given mode; Constraint Formulation for the Join Startup in Resource Groups: For a given set of units the number of startup is limited at any time.

Exemplary hydro-resource optimization equations include but are not limited to: a variety of balance equations. Generally, balance equations keep track of reservoir evolution in time. That is, any period the water in must be equal to the water out. In this context, the storage at the end of any period is equal to the storage at the end previous period, plus natural inflows, plus inflows from upstream arcs, plus inflows from downstream pumping arcs, less releases through downstream arcs, less releases through upstream pumping arcs, less evaporation losses, less seepage losses, less demand (irrigation, water supply) releases. Arc flows occur at the same period. Also, time delays for upstream arc inflows are considered by a proper weight that takes into account the release and arrival times. In addition, balance equations for junctions, tailwaters or the ground node are executed in the same manner as those with storage variables except that the storage component is excluded.

Comparatively, exemplary hydro resource optimization rules include but are not limited to: Reservoir Target Storage Rule—set a filling and empty cycle for reservoirs with downstream pumping and generating units. Reservoir storage is recovered by pumping reservoirs up to or by allowing natural inflows to provide hydro resources up to or above a given target during low demand periods. This operation is generally used for power generation during peak or high demand periods. To demonstrate the impact of this industry rule on profitability, it is recognized that with the deregulation of electricity markets the rule is undergoing a change such that the rule will become to store power and associated power when the market bears low electricity prices and to expend resources and produce power when prices increase.

Lastly, exemplary solution techniques (e.g. computational models) that may be used in hydro resource optimization include but are not limited to: Branch and Cut Algorithm. A Branch and Cut algorithm, employed by computational model engine 180a(2), to solve mixed integer linear problems consists of the following general steps: 1) Generate and solve a root problem; 2) LP relaxation; 3) Redefine original problem relaxing all integers; 4) Add cuts and solve; 5) If solution contains fractional values for integer values, try to add cuts (Cuts are “constraints” that take away those areas of the relaxed feasible region that contains fractional values for integer variables). In operation, computational model engine 180a(2) may generate different types of cuts. Also after adding cuts, computational model engine 180a(2) may attempt to re-optimize the problem. Once the problem is solved, sub-problems are then generated. At this point, if the solution still has fractional values for one or more integer variables, computational model engine 180a(2) branches in one fractional variable to generate two sub-problems, each with more restrictive bounds on the branching variable, i.e. for a binary variable: Sub-problem 1: variable fixed at 0—Sub-problem 2: variable fixed at 1. Each sub-problem may have: No fractional solution for integer variables; Makes the solution the incumbent solution and the node the incumbent node; Makes the value of the objective function as the cut off value; Prunes from the tree all the sub-problem having objective function values no better than the incumbent.

Now, if the solution satisfies the gap tolerance, then it is reported as the best solution. Otherwise computational model engine 180a(2) looks for another sub-problem to branch. At this point computational model engine 180a(2) may determine that there is no feasible solution and discard this solutions and node and proceed to determine fractional solutions for another or more integer variables. If this is the case, computational model engine 180a(2) repeats the branching process, computational model engine 180a(2) cuts off nodes when the objective function associated with sub-problems at that node is worse than the cut off value. The cut off value can be set up by default or by the user and is updated by computational model engine 180a(2) with the value of the best integer solution. When performing branching, there are several branching choices including but not limited to: Which node to branch on, within the tree; Deeper or backtrack (depth-first, best-bound, best-estimate); nWhich variable to branch on, at a node; User defined priority or program internal calculation: minimum infeasibility, maximum infeasibility, pseudo-cost, strong, pseudo-reduced costs. Also, computational model engine 180a(2) determines Which direction to branch, at a variable (e.g. Up, down or other). In addition, heuristics may be employed to obtain the desired solution. These heuristics include but are not limited to a series of special algorithms that look for integer solutions without branching. In the exemplary implementation for the solution of hydro-power resource optimization, the systems and methods described herein employ the commercially available optimization solver known as CPLEX®.

Moreover, pre-processing may be employed to reduce the size of the original variables by eliminating redundant variables and constraints and aggregating some of the them and to reduce the solution space by tightening variable bounds.

In the context of hydro resource optimization, computational model engine 180a(2) offers the following exemplary hydro resource optimization output. The output is summarized as follows: System Output—Objective Function Values by Period; Objective Function Values by Horizon (e.g. Horizons include short term, mid term and long term study horizons); Revenue, Cost and Profit by Period; Revenue, Cost and Profit by Horizon; Objective Function Revenue Components by Period; Objective Function Cost Components by Period; Objective Function Cost Adder Components by Period; System MW Load Balance by Period; System Mega-watt hours (MWh) Load Balance by Period; System MWh Load Balance by Horizon; System MW Reserve Balance by Period and by Reserve; System MW Load Feasibility Region by Period; System MW Reserve Feasibility Region by Period and by Reserve; Hydro Units Output; Hydro Units Output By Period; Hydro Units Output By Horizon; Hydro Arcs Output—Hydro Arcs Output By Period; Hydro Node Output—Hydro Node Output By Period; Reservoir Output By Period; Reservoir Balance By Period; Junction and Tail-water Balance By Period; Tail-water Output By Period; Resource Groups Output—Joint Operation Resource Groups Output by Period; Electrical Energy Transaction Resource Groups Output by Period; Reserve Transaction Resource Groups Output by Period; Transmission Zones Output—Network Charges Transmission Zones Output by Period; Transactions Output by Period.

It is understood, that although the above models, equations, and output relate to optimization of hydro resources, that the inventive concepts described herein are not limited to the optimization of hydro resources but contemplate the optimization and processing of various resource information of power systems.

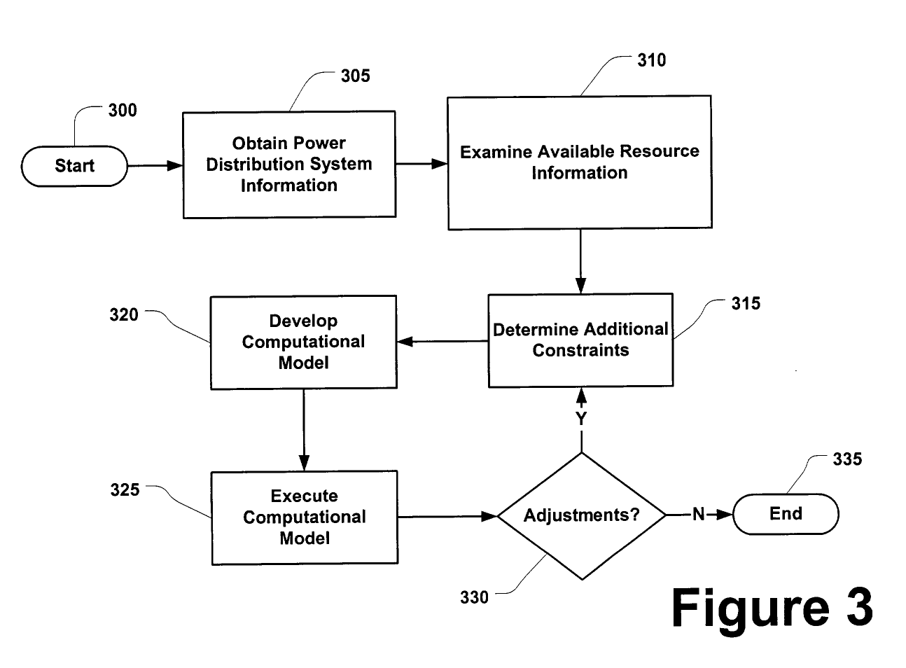

FIG. 3 shows a flow chart of the processing performed by the systems and methods described herein when obtaining the necessary data required to generate resource optimization information. As shown, processing begins at block 300 and proceeds to block 305 where characteristic information about the observed power system is obtained. Included in this information may be number of reservoirs employed, total amount of power generated, environment conditions, cascading reservoirs, discrete state of reservoirs, industry rules, logical constraint information, etc. From there, processing proceeds to block 310 where available resource information is examined. In this step, the resources information components of the characteristic power system information is separated and prepared for processing. The system and methods then determine those additional constraints that would impact the computational model processing at block 315. Included in these additional constrains might be the temperature conditions, evaporation rates, processing procedures, etc. A computational model is then developed at block 320 and then executed at block 325 on the characteristic information about the observed energy market. A check is then performed at block 330 to determine if any adjustments are necessary for the computational model. If so processing reverts to block 315 and proceeds from there. However, if no adjustments are necessary, processing terminates at block 335.

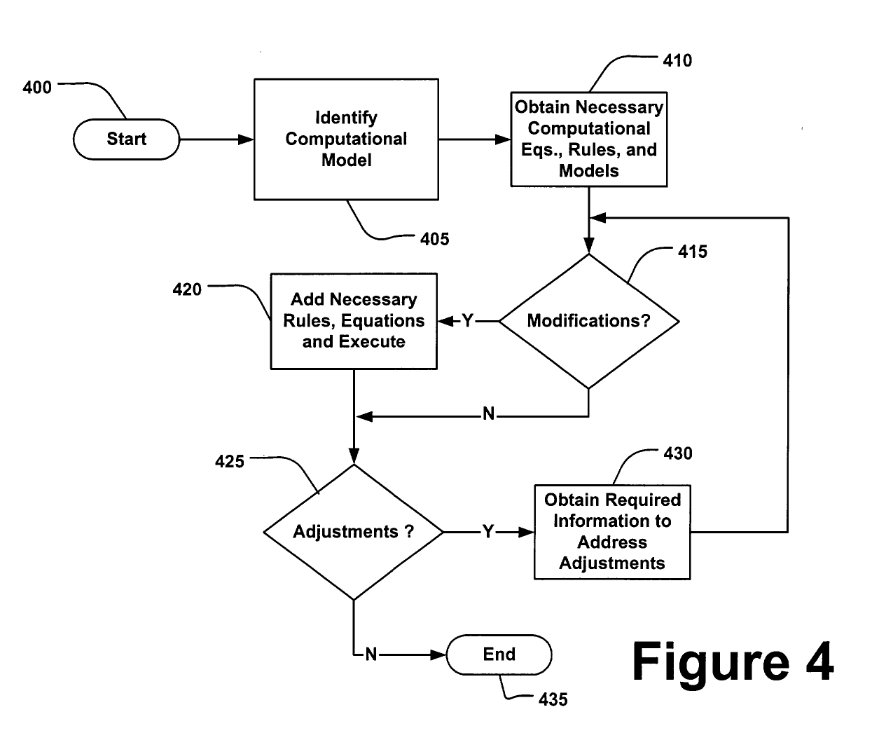

FIG. 4 with reference to FIG. 3 shows a flow chart of the processing performed at block 325 of FIG. 3 when applying the computational models to generate resource optimization information. As shown, processing begins at block 400 and proceeds to block 405 where the appropriate computational model is identified. From there, the necessary computational equations, rules, and models are obtained at block 410. In an illustrative implementation, the system and methods disclosed herein apply to the linearization of non-linear systems in an effort to more accurately and efficiently model energy market behavior. A check is then performed at block 415 to determine if there are any modifications needed to the computational model and/or computational equations, rules, and models. If there are modifications processing proceeds to block 420 where the necessary rules, equations, and/or models are added to the overall computational model. From there a check is performed to determine if any adjustments are required. If modifications are required, processing proceeds to block 430 where the necessary information to address the adjustments are retrieved. From there processing reverts to block 415 and follows from there. However, if at block 415 it is determine that there are no modifications required processing proceeds to block 425 and follow from there. Also, if at block 425 it is determined that there are no adjustments, processing terminates at block 435.

### CONCLUSION

In sum, the present invention provides system and methods to optimize resources of energy markets. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A resource optimization analysis system comprising:
an adaptable and updateable data store comprising non-linear and linear computational equations, rules, and models for use in modeling behavior of a dynamical system; and
a computational model engine, said computational model engine cooperating with said data store to apply at least one of said computational equations, rules, and/or models on energy market characteristic data to generate resource optimization information.

2. The system as recited in claim 1, wherein said data store further comprises pre-configured computational models to address resource optimization.

3. The system as recited in claim 1, wherein said power system characteristic data is non-linear and further comprises logical constraint information.

4. The system as recited in claim 3, wherein said computational model engine executes at least one equation to linearize said non-linear power distribution characteristic data when generating said resource optimization information.

5. The system as recited in claim 2, wherein said model data store comprises at least one linear computational equation for use to model the behavior of an energy market, the energy market comprising a power system.

6. The system as recited in claim 5, wherein said data store comprises data representative of rules that govern the use of resources in energy markets.

7. The system as recited in claim 6, wherein said data store comprises data representative of pricing information for energy markets.

8. The system as recited in claim 1, wherein said computational model engine comprises at least one rule for the execution of a computational equation, rule, and/or model on data representative of energy market characteristic information.

9. The system as recited in claim 8, wherein said computational model engine processes inputted power distribution characteristic data to generate said resource optimization information.

10. The system as recited in claim 1, wherein said resource optimization information comprises any of data representative of resource consumption and consumption rates, price impact resulting from resource consumption and consumption rates, resource inventory and resource expenditure.

11. The system as recited in claim 1, wherein said computational model engine comprises a computing application operating a computing environment, wherein said computing environment comprising any of: a stand-alone computing device, a fixed-wire LAN, a wireless LAN, a fixed-wire WAN, a wireless WAN, a fixed-wire intranet, a wireless intranet, the Internet, and the wireless Internet.

12. The system as recited in claim 1, wherein said resources being optimized comprise power system resources comprising any of: hydro resource, hydrothermal resources, thermal resources, fuel resources, heat resources, system security resources, fuel networks including gas network and oil network resource, pricing resources, and trading electricity, fuel and water networks.

13. A method to provide resource optimization for energy markets comprising the steps of:
(a) providing an adaptable and updateable data store comprising at least one resource computational equation, rule, and/or model; and
(b) providing a computational model engine, said computational model engine cooperating with said data store to apply said at least one resource computational equation, rule, and/or model on energy market characteristic data to generate resource optimization data, wherein said computational model engine linearizes energy market characteristic data to generate said resource optimization data.

14. The method recited in claim 13, wherein step (a) further comprises the steps of providing an energy market characteristic information data store, said energy market characteristic information data store capable of storing characteristic information about energy markets, wherein said energy market characteristic information comprises any of: non-linear data representative of energy market behavior and energy market resource optimization processing logical constraints.

15. The method recited in claim 14, wherein the step of providing said energy market characteristic information data store further comprises providing a resource characteristic data set, said resource characteristic set comprising data representative of varying resources.

16. The method recited in claim 13, wherein step (b) further comprises the step of providing a user interface cooperating with said computing application, said user interface capable of accepting information representative of energy markets.

17. The method recited in claim 16, wherein step (b) further comprises the step of processing said accepted information representative of energy markets to generate resource optimization information.

18. A computer readable medium bearing computer readable instructions for instructing a computer to carry out the steps recited in claim 13.

19. In a computing environment, a system to generate, track, manage, and store resource optimization solutions and cost analysis information for communicated energy markets comprising:
a data store comprising computational equations, rules, and models, representative of energy market operation constraints; and
a computational model engine, computational model engine having a user interface to accept information representative of energy markets and cooperating with said data store to generate resource optimization and utilization solutions and cost analysis for inputted data representative of energy markets.

20. The system recited in claim 19, wherein said user interface of said computational model engine comprises at least one dialog interface data field capable of accepting and displaying information representative of energy markets.

21. The system recited in claim 20, wherein said at least one dialog interface data field comprises a pull down menu dialog interface data field having pre-populated data representative of energy markets.

22. The system recited in claim 19, wherein said computational model engine comprises a computing application operating in a computing environment, said computing environment comprising any of a stand-alone computing device, a fixed-wire LAN, a wireless LAN, a fixed-wire WAN, a wireless WAN, a fixed wire intranet, a wireless intranet, the Internet, and the wireless Internet.

23. A method to provide resource optimization solutions for energy market projects comprising the steps of:
accepting information indicative of energy markets parameters by a computing application, said computing application having a user interface to accept said information;
retrieving appropriate energy market models by said computing application from a resource computational model engine cooperating with said computing application that address said energy market project parameters, said resource computational models comprising data representative of resource computational equations; and
applying appropriate heuristic rules by said computing application from said resource computational model engine cooperating with said computing application to generate resource optimization solutions for said accepted energy market project parameters.

24. The method recited in claim 23, wherein the step of applying heuristic rules further comprises the step of cycling through all of the rules contained in said rules data store to find the appropriate rules to apply to said energy market project information.

25. A computer-readable medium bearing computer-readable instructions for instructing a computer to carry out the steps recited in claim 20.

26. A method to determine the benefit and costs of an energy market resource optimization comprising the steps of:
accepting from energy market participants specifications for energy markets, wherein energy markets comprise power systems; and
processing said specifications for energy markets using a computing application providing energy market resource optimization solutions and cost analysis information to determine the costs associated with said accepted energy market specifications.

27. The method recited in claim 26, further comprising the step of communicating said energy market resource optimization solutions and said cost analysis information for said energy markets to energy market participants to ascertain the value of proposed energy market optimizations.

28. A method to optimize resources for energy markets comprising the steps of:
accepting data representative of energy market characteristic behavior information, said energy market characteristic behavior information being non-linear;
linearizing said energy market characteristic behavior using at least one computational model to generate at least one linear equation that represents the behavior of said energy markets; and
solving said linear equation to generate data, said data being representative of resource optimization for said energy markets.
